(19) United States
(12) Patent Application Publication
(10) Pub. No.: US 2025/0030192 A1
(43) Pub. Date: Jan. 23, 2025

(54) ELECTRICAL CONNECTOR SYSTEM

(71) Applicant: Lear Corporation, Southfield, MI (US)

(72) Inventors: Chao Fang, Shanghai (CN); Zhipeng Bai, Shanghai (CN)

(73) Assignee: Lear Corporation, Southfield, MI (US)

(21) Appl. No.: 18/737,006

(22) Filed: Jun. 7, 2024

(30) Foreign Application Priority Data
Jul. 21, 2023 (CN) 202310901611.2

(51) Int. Cl. H01R 13/52; H01R 13/66; H01R 24/28

(52) U.S. Cl. CPC H01R 13/5213; H01R 13/521; H01R 13/665; H01R 24/28

(57) ABSTRACT

An electrical connector system that has a base, a back cover, and a seal. The base has a housing that includes a first perimeter wall and a second perimeter wall spaced from the first perimeter wall. The first perimeter wall defines a first opening. The second perimeter wall defines a second opening. The back cover includes a plate configured to be secured against the second perimeter wall to cover the second opening and a seal securement flange that is configured to fit within the second perimeter wall when the back cover is in a closed position relative to the base. The seal extends around a perimeter of the seal securement flange, is retained by and movable with the back cover, and is configured to be elastically compressed between the seal securement flange and an inner surface of the second perimeter wall when the back cover is in the closed position.

### FIELD

This disclosure relates to an electrical connector system, and more particularly to an electrical connector system with a connector position assurance element.

### BACKGROUND

Electrical connectors are known that provide convenient and quick electrical connections. Such electrical connectors may be employed in automotive vehicles that employ high voltage for particular vehicle systems, such as a high voltage charging system. It is desirable to employ improved connectors in such systems.

### SUMMARY

According to an aspect, the disclosure provides an electrical connector system that includes: a base having a housing including a first perimeter wall and a second perimeter wall spaced from the first perimeter wall, the first perimeter wall configured to receive a plurality of cables extending therethrough and defining a first opening configured to provide access for an electrical connection to the plurality of cables, and the second perimeter wall defining a second opening on an opposed side from the first opening; a back cover including a plate configured to be secured against the second perimeter wall to cover the second opening and a seal securement flange extending generally perpendicular from the plate and configured to fit within the second perimeter wall when the back cover is in a closed position relative to the base; and a seal extending around a perimeter of the seal securement flange, retained by and movable with the back cover, the seal configured to be elastically compressed between the seal securement flange and the second perimeter wall when the back cover is in the closed position.

According to an aspect, the disclosure provides an electrical connector system that includes a base having a housing including a first perimeter wall and a second perimeter wall spaced from the first perimeter wall, the first perimeter wall configured to receive a plurality of cables extending therethrough and defining a first opening configured to provide access for an electrical connection to the plurality of cables, and the second perimeter wall defining a second opening on an opposed side from the first opening; a back cover including a plate configured to be secured against the second perimeter wall to cover the second opening when the back cover is in a closed position relative to the base; and a high voltage interlock system comprising a pair of electrically conductive HVIL pads on one of the back cover and the housing and a pair of electrically conductive HVIL pins on the other of the back cover and the housing, wherein each of the HVIL pads is configured to contact a respective one of the HVIL pins only when the back cover is in the closed position.

According to an aspect, an electrical connector system is provided that allows for connecting components of a high voltage system while indicating a back cover closure with a low voltage system (high voltage interlock (HVIL) system). According to an aspect, a seal may compress between a flange on a back cover and a wall on a base to seal between the back cover and the base while also assisting in securing the back cover in a closed position relative to the base. According to an aspect, the electrical connector system may include a connector position assurance (CPA) member to assure an electrical connection is maintained.

Various aspects of an electrical connector system will become apparent to those skilled in the art from the following detailed description of the embodiments, when read in light of the accompanying drawings.

### BRIEF DESCRIPTION OF THE DRAWINGS

FIG. 1 is a schematic, perspective view of a portion of an electrical connector system.

FIG. 2 is a schematic, perspective view of a portion of the electrical connector system of FIG. 1, shown from a different perspective.

FIG. 3 is a schematic, perspective view of a portion of the electrical connector system of FIG. 1, shown from a different perspective.

FIG. 4 is a schematic, end view of a portion of the electrical connector system of FIG. 1.

FIG. 5 is a schematic, side view of a portion of the electrical connector system of FIG. 1.

FIG. 6 is a schematic, perspective view of a portion of the electrical connector system of FIG. 1, with a back cover shown in an open position.

FIG. 7 is a schematic, perspective view of a portion of the electrical connector system of FIG. 6, but on an enlarged scale.

FIG. 8 is a schematic, sectional view of a portion of the electrical connector system of FIG. 1.

FIG. 9 is a schematic, perspective view of a portion of the electrical connector system of FIG. 6, but on an enlarged scale.

FIG. 10 is a schematic, perspective view of a portion of an electrical connector system similar to FIG. 1 but configured for a round cable type.

FIG. 11 is a schematic, perspective view of a portion of the electrical connector system of FIG. 10, shown from a different perspective.

FIG. 12 is a schematic, perspective view of a portion of the electrical connector system of FIG. 10, shown from a different perspective.

FIG. 13 is a schematic, perspective view of a portion of an electrical connector system similar to FIG. 1 but configured for a fold-flat cable type.

FIG. 14 is a schematic, perspective view of a portion of the electrical connector system of FIG. 13, shown from a different perspective.

### DETAILED DESCRIPTION

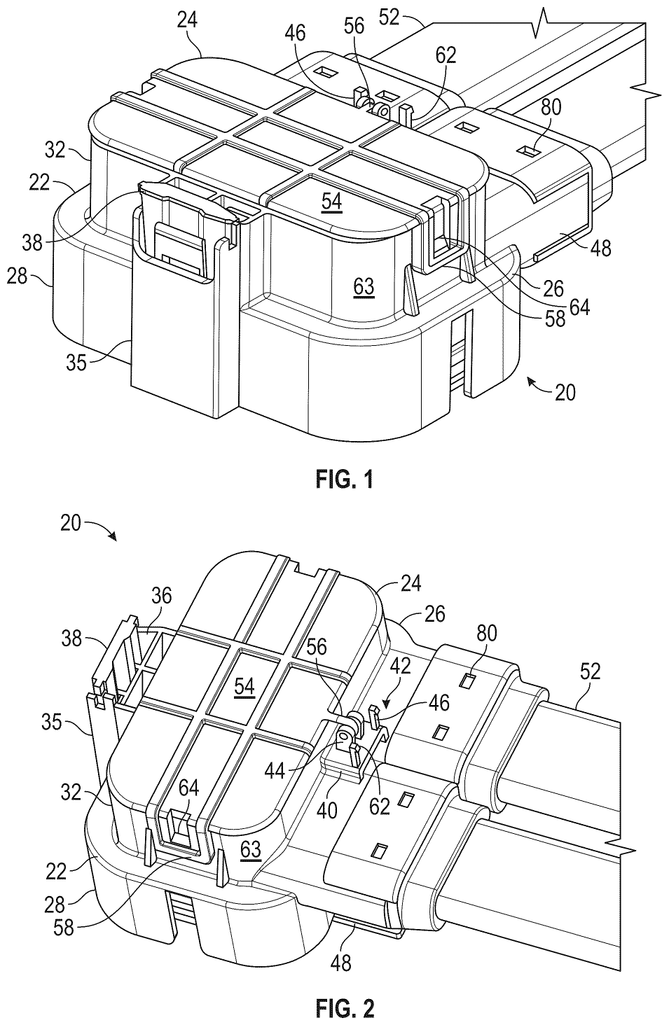

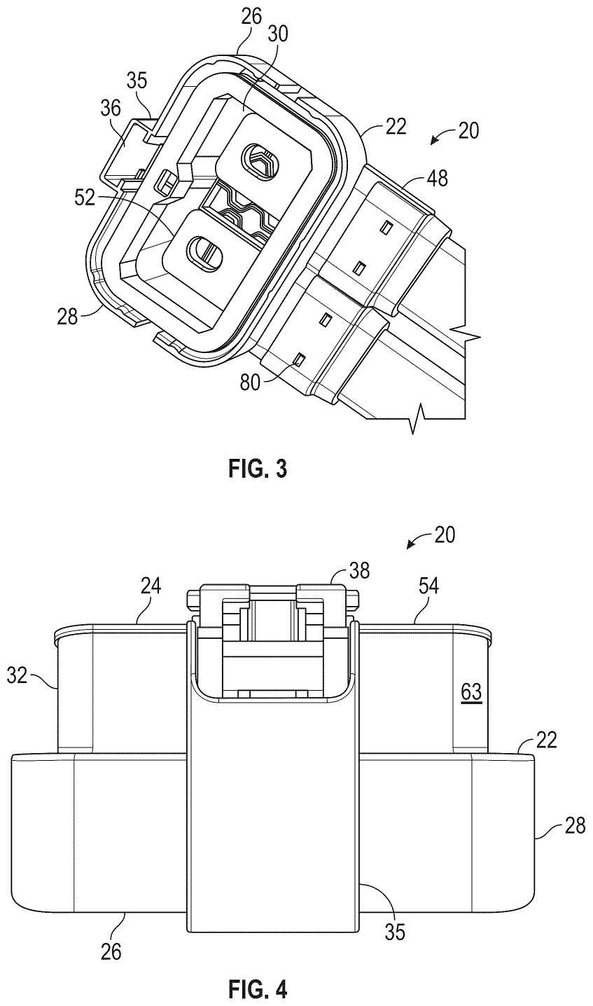

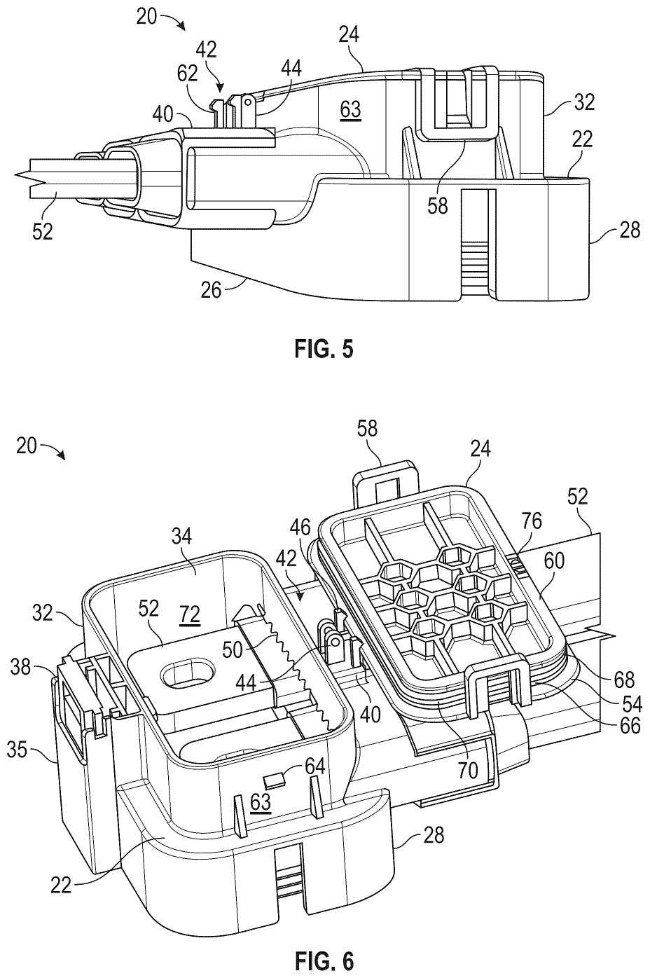

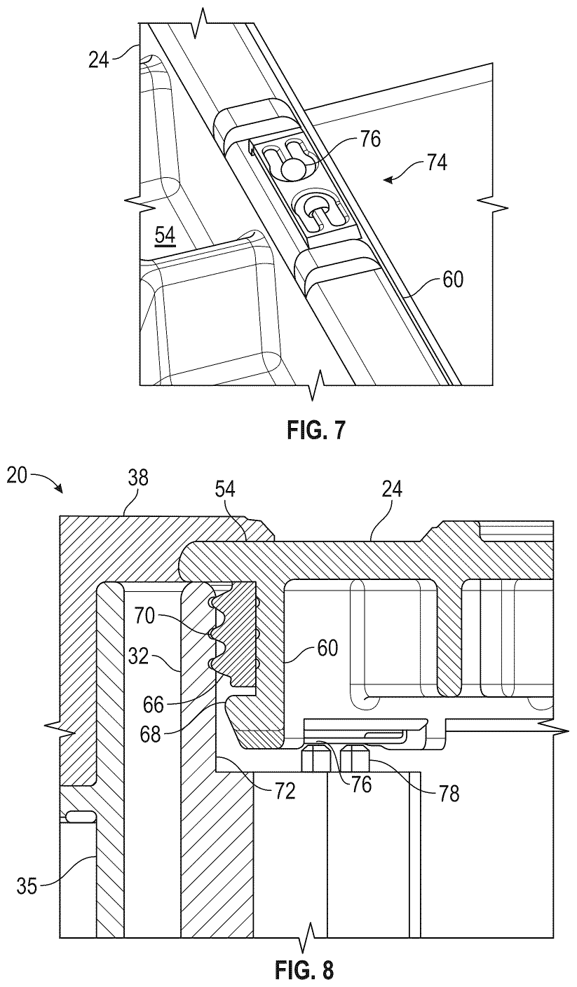

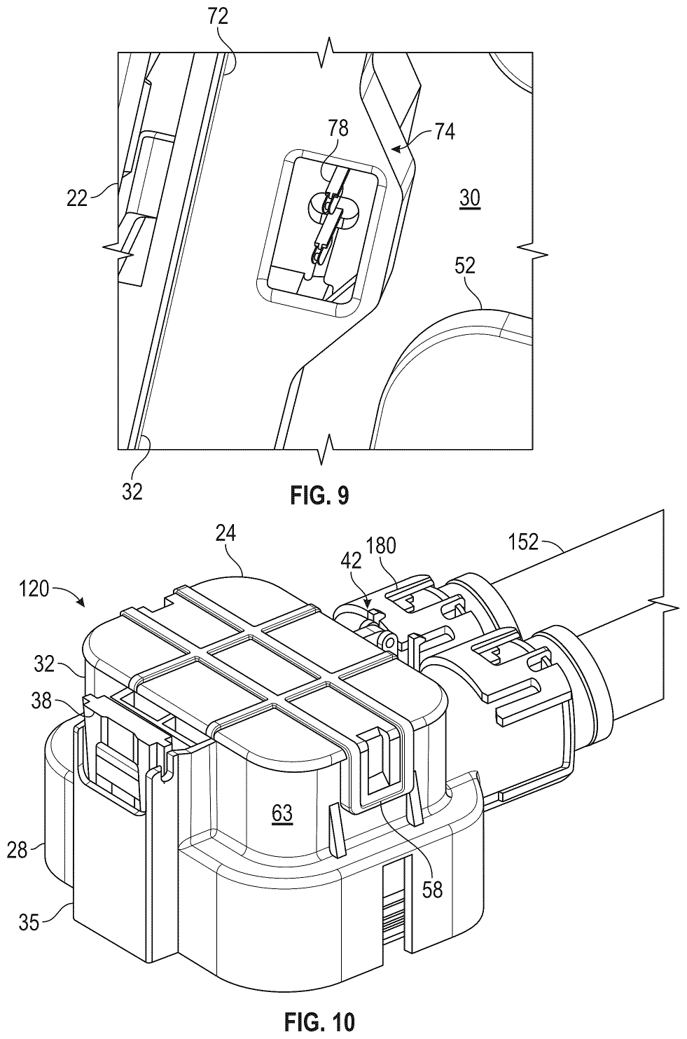

Referring now to the drawings, an example is illustrated in FIGS. 1-9 of an electrical connector system 20. The electrical connector system 20 comprises a base 22 and a back cover 24. The base 22 comprises a housing 26, which may be formed of an electrically insulating material, having a first perimeter wall 28 defining an opening 30 for receiving another portion (not shown) of the electrical connector system 20 and a second perimeter wall 32 defining an opening 34 that is selectively closed by the back cover 24. The base 22 comprises a member 35 that defines a cavity 36 configured to slidably receive a connector position assurance (CPA) member 38 and a base hinge 40 of a pivoting hinge assembly 42. The base hinge 40 comprises a pair of hinge arms 44 and a pair of hold-open flanges 46 adjacent to the hinge arms 44. The base 22 comprises a cable connection member 48 defining a pair of cable channels 50, which are configured to receive a pair of flat cables 52 therethrough. The housing 26 may be formed (e.g., molded) as a singled piece.

The back cover 24 of the example illustrated in FIGS. 1-9 comprises a plate 54 from which a cover hinge arm 56 extends, a pair of snap-fitting connectors 58 extend, and a seal securement flange 60 extends, all of which may be formed of an electrically insulating material. The cover hinge arm 56 mates with the pair of hinge arms 44 to form the pivoting hinge assembly 42, which pivotally attaches the back cover 24 to the base 22. The hold-open flanges 46 are configured to retain the back cover 24 in the open position and flex to allow for movement of the back cover 24 into the closed position. The pair of hold-open flanges 46 each includes a barb 62 that selectively mates with an edge of the plate 54 when in an open position (illustrated in FIG. 6), to hold the back cover 24 in the open position until one pivots the back cover 24 into a closed position (illustrated in FIGS. 1-5 and 8). As the back cover 24 is pivoted toward the closed position, the pair of snap-fitting connectors 58 slide over an outside surface 63 of the second perimeter wall 32 and elastically engage with a corresponding pair of barbs 64 extending from the second perimeter wall 32, on opposed sides of the base 22, to assist in securing the back cover 24 to the base 22 in the closed position. The back cover 24 may be formed (e.g., molded) as a single piece. A seal 66, which is elastomeric, is mounted to extend around a perimeter of the seal securement flange 60 and is retained between the plate 54 and a lip 68 extending generally radially outward from the seal securement flange 60 to hold the seal 66 in position whether the back cover 24 is in the open or closed position. The seal 66 has three generally radially outwardly extending protrusions 70 which, when the back cover 24 is in the closed position, are elastically biased against an inner surface 72 of the second perimeter wall 32 (e.g., are pressed against the inner surface 72 of the second perimeter wall 32) to assist in securing the back cover 24 to the base in the closed position and to seal the back cover 24 to the base 22 (i.e., prevent moisture and debris from entering the electrical connector system 20 between the base 22 and the back cover 24). The term radially, as used herein, relates to extending generally outward away from a center of the structure and to extending generally inward toward the center of the structure (even though the first perimeter wall 28, second perimeter wall 32 and the seal securement flange 60 are not circular). The seal 66, when compressed, creates a bias against the inner surface 72 in a direction normal to the direction the back cover 24 is moving when pushed a last distance into the closed position. This bias force pushing radially outwardly on the inner surface 72, then assists in retaining the back cover 24 in the closed position relative to the base 22. The snap-fitting connectors 58 and seal 66 secure the back cover 24 in the closed position relative to the base 22 without needing a fastener to hold them together.

The example of the electrical connector system 20 illustrated in FIGS. 1-9 also comprises a high voltage interlock (HVIL) system 74, which is a low voltage system that indicates the status (i.e., closed position or not) of the back cover 24 relative to the base 22 of the electrical connector system 20. The electrical connector system 20 may connect the flat cables 52 to other cables, where the connection is part of a high voltage system (e.g., about 250-600 volts), while the HVIL system 74 may form a portion of a low voltage (e.g., 5 volts, 12 volts, 24 volts) system, which is employed to detect the closed position of the back cover 24, sealing off the electrical components of the high voltage portion of the electrical system. The HVIL system 74 comprises a pair of electrically conductive HVIL pads 76 affixed to the seal securement flange 60 and a corresponding pair of electrically conductive HVIL pins 78 secured to the second perimeter wall 32 of the base 22. The HVIL pads 76 may be molded into the back cover 24. The HVIL pads 76 move with the back cover 24 as it is moved between the open and closed positions. The HVIL pins 78 may be molded into the housing 26. The HVIL pads 76 and the HVIL pins 78 are positioned so the respective ones of each are brought into contact when the back cover 24 is moved into its closed position. This contact completes a circuit for the HVIL system 74, providing a low voltage indicator that the back cover 24 is in the closed position (e.g., the HVIL is configured to operate at a lower voltage than a voltage of the plurality of cables 52), achieving an HVIL functional indicator as to the position of the back cover 24.

The example of the electrical connector system 20 illustrated in FIGS. 1-9 also comprises cable fixation members 80 on the cable connection member 48. When the flat cables 52 are inserted through the cable channels 50 into the final position, the cable fixation members 80 secure the flat cables 52 to the base 22.

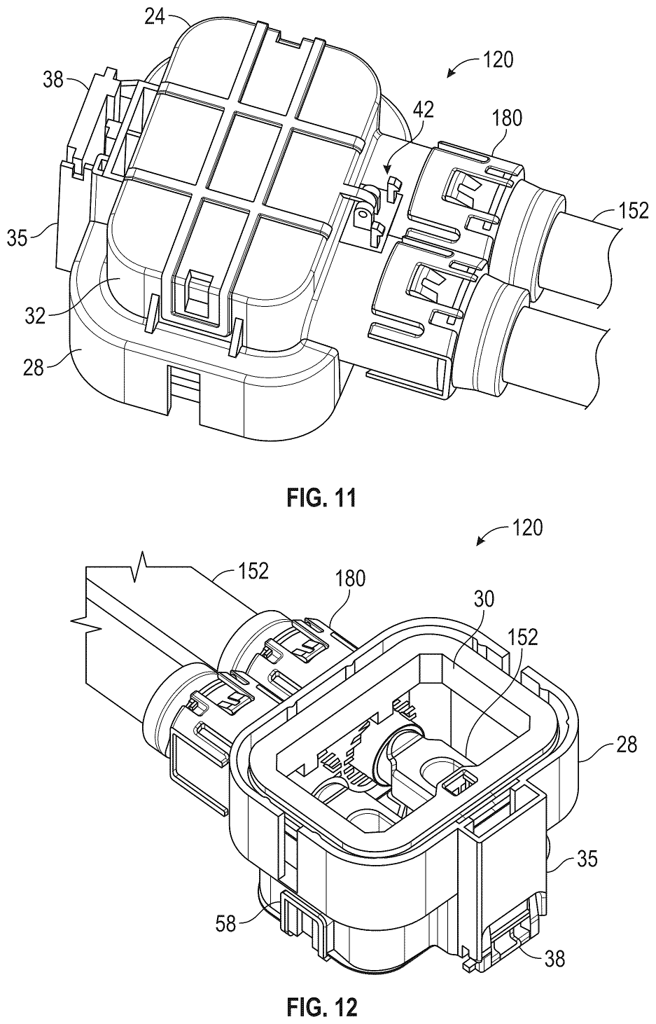

FIGS. 10-12 illustrate an example of an electrical connector system 120 similar to that illustrated in FIG. 1 but configured for a round cable 152 type. Since the electrical connector system 120 in this example is a modification of that illustrated in FIG. 1 and has many elements in common with that of FIG. 1, like reference numbers designate corresponding parts in the drawings and to avoid unnecessary repetition of the description, the detailed description thereof will be omitted. The round cables 152 slide into the first perimeter wall 28 and are secured therein by cable fix members 180. The back cover 24 may operatively engage the base in essentially the same way as that illustrated in the example of FIGS. 1-9.

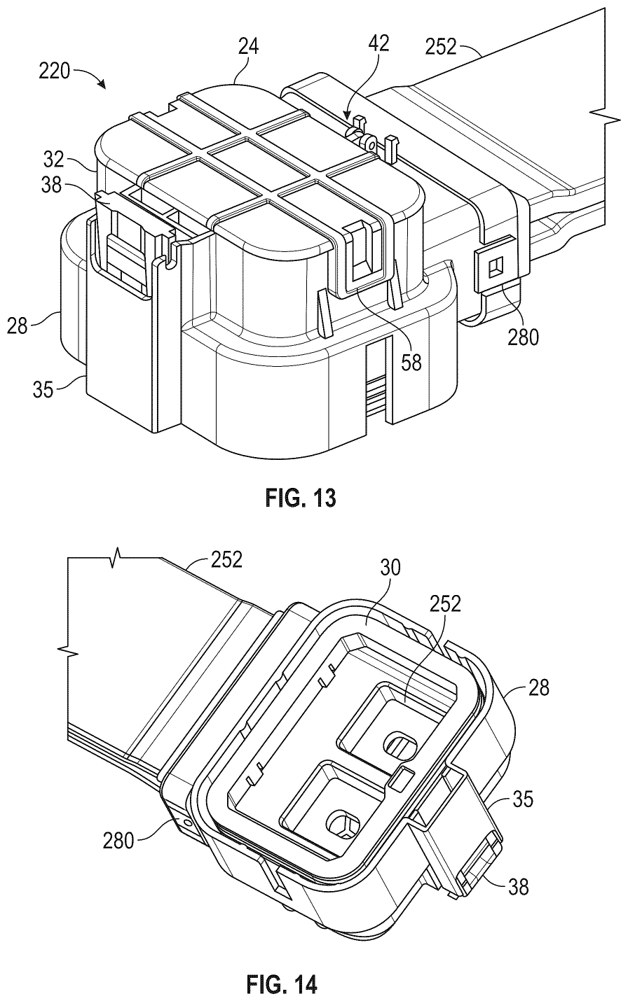

FIGS. 13 and 14 illustrate an example of an electrical connector system 220 similar to that illustrated in FIG. 1 but configured for a fold-flat cable 252 type. Since the electrical connector system 220 in this example is a modification of that illustrated in FIG. 1 and has many elements in common with that of FIG. 1, like reference numbers designate corresponding parts in the drawings and to avoid unnecessary repetition of the description, the detailed description thereof will be omitted. The fold flat cables 252 slide into the first perimeter wall 28 and are secured therein by cable fix members 280. The back cover 24 may operatively engage the base in essentially the same way as that illustrated in the example of FIGS. 1-9.

The principle and mode of operation of the electrical connector systems described herein have been explained and illustrated as example embodiments. However, it must be understood that an electrical connector system may be practiced otherwise than as specifically explained and illustrated without departing from its spirit or scope.

What is claimed is:

1. An electrical connector system comprising:
a base having a housing including a first perimeter wall and a second perimeter wall spaced from the first perimeter wall, the first perimeter wall configured to receive a plurality of cables extending therethrough and defining a first opening configured to provide access for an electrical connection to the plurality of cables, and the second perimeter wall defining a second opening on an opposed side from the first opening;
a back cover including a plate configured to be secured against the second perimeter wall to cover the second opening and a seal securement flange extending generally perpendicular from the plate and configured to fit within the second perimeter wall when the back cover is in a closed position relative to the base; and
a seal extending around a perimeter of the seal securement flange, retained by and movable with the back cover, the seal configured to be elastically compressed between the seal securement flange and an inner surface of the second perimeter wall when the back cover is in the closed position.

2. The electrical connector system of claim 1 wherein the back cover includes a lip, spaced from the plate and extending generally radially outward from the seal securement flange, wherein the seal is retained between the plate and the lip.

3. The electrical connector system of claim 1 wherein the base includes a base hinge arm and the back cover includes a cover hinge arm pivotally engaged to the base hinge arm to pivotally secure the back cover to the base for pivoting between an open position wherein the plate is spaced from the second opening to allow access to the second opening and the closed position wherein the plate covers the second opening.

4. The electrical connector system of claim 3 wherein the base includes a hold-open flange adjacent to the base hinge arm, wherein the hold-open flange is configured to retain the back cover in the open position and flex to allow for movement of the back cover into the closed position.

5. The electrical connector system of claim 1 wherein the seal includes a protrusion extending generally radially outward and configured to be pressed against the inner surface of the second perimeter wall.

6. The electrical connector system of claim 1 wherein the base includes a pair of barbs on an outside surface of the second perimeter wall on opposed sides of the base, and the back cover includes a pair of snap-fitting connectors each configured to mate with and be retained by a respective one of the barbs when the back cover is in the closed position.

7. The electrical connector system of claim 1 further comprising a connector position assurance member, and wherein the housing includes a cavity configured to slidably receive the connector position assurance member.

8. The electrical connector system of claim 1 further including a high voltage interlock system comprising a pair of electrically conductive HVIL pads on one of the back cover and the housing and a pair of electrically conductive HVIL pins on the other of the back cover and the housing, wherein each of the HVIL pads is configured to contact a respective one of the HVIL pins when the back cover is in the closed position.

9. The electrical connector system of claim 8 wherein the high voltage interlock system is configured to operate at a lower voltage than a voltage of the plurality of cables.

10. The electrical connector system of claim 1 wherein the base includes a cable fixation member configured to retain the plurality of cables to the base.

11. The electrical connector system of claim 1 wherein the first perimeter wall is configured to receive the plurality of cables wherein the plurality of cables are flat cable types.

12. The electrical connector system of claim 1 wherein the first perimeter wall is configured to receive the plurality of cables wherein the plurality of cables are round cable types.

13. The electrical connector system of claim 1 wherein the first perimeter wall is configured to receive the plurality of cables wherein the plurality of cables are fold flat cable types.

14. An electrical connector system comprising:
a base having a housing including a first perimeter wall and a second perimeter wall spaced from the first perimeter wall, the first perimeter wall configured to receive a plurality of cables extending therethrough and defining a first opening configured to provide access for an electrical connection to the plurality of cables, and the second perimeter wall defining a second opening on an opposed side from the first opening;
a back cover including a plate configured to be secured against the second perimeter wall to cover the second opening when the back cover is in a closed position relative to the base; and
a high voltage interlock system comprising a pair of electrically conductive HVIL pads on one of the back cover and the housing and a pair of electrically conductive HVIL pins on the other of the back cover and the housing, wherein each of the HVIL pads is configured to contact a respective one of the HVIL pins only when the back cover is in the closed position.

15. The electrical connector system of claim 14 wherein the high voltage interlock system is configured to operate at a lower voltage than a voltage of the plurality of cables.

16. The electrical connector system of claim 14 wherein the back cover is pivotally secured to the base.

17. The electrical connector system of claim 14 wherein the back cover includes a seal that is configured to be biased radially inward against an inside surface of the second perimeter wall when the back cover is in the closed position; and
wherein the seal is retained by the back cover and moves with the back cover between an open position and the closed position.

18. The electrical connector system of claim 14 wherein the HVIL pads are secured to the back cover by being molded into the back cover.

19. The electrical connector system of claim 14 further comprising a connector position assurance member; and
wherein the housing includes a cavity configured to slidably receive the connector position assurance member.

20. An electrical connector system comprising:
a base having a housing including a first perimeter wall and a second perimeter wall spaced from the first perimeter wall, the first perimeter wall configured to receive a plurality of cables extending therethrough and defining a first opening configured to provide access for an electrical connection to the plurality of cables, and the second perimeter wall defining a second opening on an opposed side from the first opening;
a back cover including a plate configured to be secured against the second perimeter wall to cover the second opening and a seal securement flange extending generally perpendicular from the plate and configured to fit within the second perimeter wall when the back cover is in a closed position relative to the base, the back cover pivotally secured to the base;
a seal extending around a perimeter of the seal securement flange, retained by and movable with the back cover, the seal configured to be elastically compressed between the seal securement flange and an inner surface of the second perimeter wall when the back cover is in the closed position; and
a high voltage interlock system comprising a pair of electrically conductive HVIL pads on one of the back cover and the housing and a pair of electrically conductive HVIL pins on the other of the back cover and the housing, wherein each of the HVIL pads is configured to contact a respective one of the HVIL pins only when the back cover is in the closed position.
